(19) United States
(12) Patent Application Publication
(10) Pub. No.: US 2008/0133723 A1
(43) Pub. Date: Jun. 5, 2008

(54) EXTENDED HOME SERVICE APPARATUS AND METHOD FOR PROVIDING EXTENDED HOME SERVICE ON P2P NETWORKS

(75) Inventors: Il Woo Lee, Daejeon (KR); Moon Ok Choi, Cheongjoo (KR); Sang Ok Lee, Daejeon (KR); Ho Jin Park, Daejeon (KR); Chae Kyu Kim, Daejeon (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: ELECTRONICS & TELECOMMUNICATIONS RESEARCH INSTITUTE, Daejeon (KR)

(21) Appl. No.: 11/950,162

(22) Filed: Dec. 4, 2007

(30) Foreign Application Priority Data
Dec. 4, 2006 (KR) 10-2006-0121321
Apr. 4, 2007 (KR) 10-2007-0033325

(51) Int. Cl. G06F 15/177; G06F 15/173

(52) U.S. Cl. 709/222; 709/223

(57) ABSTRACT

An extended home service apparatus and a method of provided an extended home service capable of easily developing an application service based on a peer-to-peer (P2P) network are provided. The extended home service apparatus for providing an extended home service to a user in a P2P network in which a plurality of peer terminals provided with the extended home service apparatuses are connected to each other via a virtual home network, the extended home service apparatus comprising: a middleware which manages a protocol for communication with other peer terminals and providing the extended home service on the P2P network; a peer/peer group management service module which manages information on the peers and information on peer groups by using the protocol managed by the middleware and communicates with other peer terminals activated on the P2P network; a basic service module which generates and manages information on services which are to be provided to the user; and an application service module which provides an interface to the user and the other peer terminals by using the protocol managed by the middleware, calls a service requested by the user from the basic service module, and provides the service to the user. Accordingly, users can be rapidly provided with various contents and services anytime, anywhere via a virtual home network.

### CROSS-REFERENCE TO RELATED APPLICATIONS

This application claims the priority of Korean Patent Application No. 10-2006-121321 filed on Dec. 4, 2006 and No. 10-2007-33325 filed on Apr. 4, 2007 in the Korean Intellectual Property Office, the disclosure of which is incorporated herein by reference.

### BACKGROUND OF THE INVENTION

1. Field of the Invention

The present invention relates to a peer-to-peer (P2P) network, and more particularly, to an extended home service apparatus and a method of providing an extended home service in a P2P network.

This work party supported by the IT R&D program of MIC/ITA [2006-S-068-01, Development of Virtual Home Platform based on Peer-to-Peer Networking].

2. Description of the Related Art

Recently, due to development of communication environment and advent of high-performance personal terminals, sharing of contents and services between the personal terminals or apparatuses have been increasingly demanded so that the contents and services are available anytime, anywhere. Therefore, a technology for searching and sharing the contents and service between the personal terminal apparatuses in a virtual space for seamless connection between the personal terminal apparatuses has been demanded. As an example of the technology, there has been proposed a peer-to-peer (P2P) technology. In general, the P2P technology is used in a ubiquitous environment to provide a service for allowing users to share user resources on various wired or wireless networks by using personal terminals of the users.

However, for the conventional P2P services, service platforms suitable for characteristics of the services need to be separately developed and provided. The service platforms depending on the services are different among P2P service providers. Most of the current P2P services are a file sharing service. The conventional service platforms suitable for the file sharing service are also developed and provided.

In the near future, it is expected that a UCC (User Created Contents)-based personal broadcasting service or a UCC commercial transaction service will be main P2P services. In this circumstance, the conventional platforms need to be greatly revised. In addition, the revised platforms need to be inconveniently installed into personal terminals of the users. In addition, service developers or providers need to separately develop and manage different service platforms depending on the different services.

### SUMMARY OF THE INVENTION

As an aspect of the present invention provides an extended home service apparatus and a method of providing an extended home service capable of easily developing an application service based on a P2P (peer-to-peer) network. According to an aspect of the present invention, there is provided an extended home service apparatus for providing an extended home service to a user in a P2P (peer-to-peer) network for connecting a plurality of peer terminals in which the extended home service apparatuses are included the peer terminals, the extended home service apparatus comprising: a middleware which manages a protocol for communication with other peer terminals and providing the extended home service on the P2P network; a peer/peer group management service module which manages information on the peers and information on peer groups by using the protocol managed by the middleware and communicates with other peer terminals activated on the P2P network; a basic service module which generates and manages information on services which are to be provided to the user; and an application service module which provides an interface to the user and the other peer terminals by using the protocol managed by the middleware, calls a service requested by the user from the basic service module, and provides the service to the user.

According to another aspect of the present invention, there is provided a method for providing an extended home service to a user in an extended home service apparatus provided to an arbitrary peer terminal among peer terminals in a P2P network in which a plurality of the peer terminals provided with the extended home service apparatuses are connected to each other via a virtual home network, the method comprising: performing initialization for registering peer configuration information of the P2P network and executing a service; setting edge peer environment information by using the registered peer configuration information when the user has access to the arbitrary peer terminal; searching for peer terminals activated on the P2P network; registering information on the searched interested peer terminals in a list of peer terminals; and performing a service with a interested peer terminal which the user selects from the list of peer terminals and providing the service to the user.

According to still another aspect of the present invention, there is provided a method for providing an extended home service to a user in an extended home service apparatus provided to an arbitrary peer terminal among peer terminals in a P2P network in which a plurality of the peer terminals provided with the extended home service apparatuses are connected to each other via a virtual home network, the method comprising: performing initialization for registering peer configuration information of the P2P network and executing a service; setting edge peer environment information by using the registered peer configuration information when the user has access to the arbitrary peer terminal; searching for peer groups generated by other peer terminals activated on the P2P network when the user requests for executing a peer-group-based service; registering information on a peer group which the user selects from the searched interested peer groups in a list of peer groups; performing a subscribing process for taking part in a peer group which the user selects from the interested peer groups registered in the list of peer groups; and performing a service with the subscribed peer group and providing the service to the user.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view illustrating a configuration of a peer-to-peer (P2P) network in which an extended home service is provided according to an embodiment of the present invention;

FIG. 2 is a block diagram illustrating an P2P-network-based extended home service apparatus according to an embodiment of the present invention; and

FIG. 3 is a flowchart illustrating a method in which a P2P-network-based extended home service apparatus provides an extended home service according to an embodiment of the present invention.

### DETAILED DESCRIPTION OF THE PREFERRED EMBODIMENT

Hereinafter, exemplary embodiments of the present invention will now be described in detail with reference to the accompanying drawings. In the accompanying drawings, like reference numerals denote like elements. For clarifying of the present invention, description of well-known functions, structures, configuration, or constructions may be omitted.

The present invention provides a peer-to-peer (P2P) network-based extended home service using a P2P communication technology which allows user terminals to directly exchange data without a server system so as to share digital resources such as CPUs, hard disks, and contents. The extended home service is a virtual-space service using a P2P networking technique, in which the users can easily have access to indoor or outdoor terminals beyond a physical limitation, that is, in an extended region.

Due to the P2P-network-based extended home service, personal apparatuses or apparatuses which are shared by groups can be integrated into one virtual space via a virtual network. Accordingly, users can have access to various terminals and share contents anytime, anywhere. As an infrastructure for providing the extended home service, there is a JXTA (juxtapose) middleware that is an open-source type infrastructure introduced by SUN Microsystems, Inc.

Therefore, the embodiments of the present invention will be described based on the JXTA middleware. In addition, a service platform (hereinafter, referred as a service apparatus) used for developing and providing the P2P-network-based extended service and a method of providing the extended home service to the service apparatus will be also described in detail based on the JATA middleware. Firstly, a P2P network used for providing the P2P-network-based extended home service will be described with reference to the accompanying drawings.

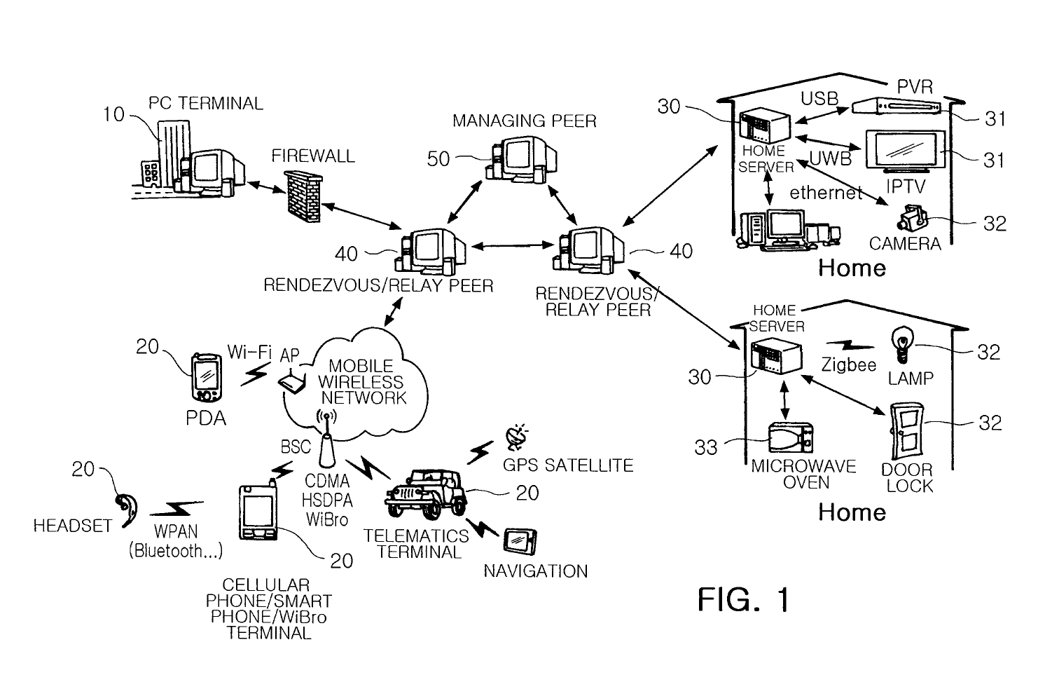

FIG. 1 is a view illustrating a configuration of the P2P network used to proving the P2P-network-based extended home service according to the embodiment of the present invention.

Referring to FIG. 1, the P2P network is configured in a ubiquitous environment, in which terminals (hereinafter, sometimes referred to as peers) that are distributed over offices, moving objects (for example, vehicles), homes, or personal spaces are connected to each other in the P2P scheme so that services or contents can be easily searched and shared anytime, anywhere.

Currently, most of the peers in offices, home, or an Ad-hoc network are PC terminals 10 on the wired Internet. In consideration of the trend of development of communication technology, it is expected that the main peers will be mobile terminals 20.

In a home network, entertainment apparatuses 31 such as PVRs and IPTVs, home automation apparatuses 32 such as cameras, lamps, door locks, and gas valves, and consumer electronics and appliances 33 such as microwave ovens and refrigerators are connected to each other via a home server 30. For the P2P networking in the home network, P2P platforms are not directly embedded into the in-door apparatuses (peers), but a legacy device agent is provided to the home server. The peers 10, 20, and 30 are connected to each other through rendezvous/relay peers 40.

Each rendezvous/relay peer 40 is operative as a super peer. In general, the P2P-network-based service results in a large amount of traffics on a transport network. Therefore, particular peers such as the rendezvous/relay peer 40 are additionally required so as to ensure a quality of service. When the indoor or outdoor peers search for counterpart peers, information, or services, the rendezvous/relay peers 40 relay and propagate associated queries of the peers. A relay peer in each rendezvous/relay peer 40 supports apparatuses having no Internet Protocol (IP) address or peers which cannot directly communicate due to a firewall/network address transducer (Firewall/NAT), so that the apparatuses and peers can transmit and receive messages. In general, the rendezvous peer and the relay peer are integrated into one peer terminal in physical and operational points of view.

The rendezvous/relay peers 40 are connected to a managing peer 50. The managing peer 50 has functions of managing states, failure, or configuration information of the rendezvous/relay peers 40. In addition, the rendezvous/relay peers 40 may perform a service subscriber registration procedure or an authentication process.

The PC terminals 10, mobile terminals 20, and home server 30 having the aforementioned configuration are operated as edge peers that are provided with the extended home service apparatuses according to the present invention. In addition, the rendezvous/relay peers 40 may be operated as edge peers that provided with the aforementioned extended home service apparatuses.

Now, the P2P-network-based extended home service apparatus (service platform) that are provided to the peer terminals on the P2P network will be described in detail with reference to the accompanying drawings.

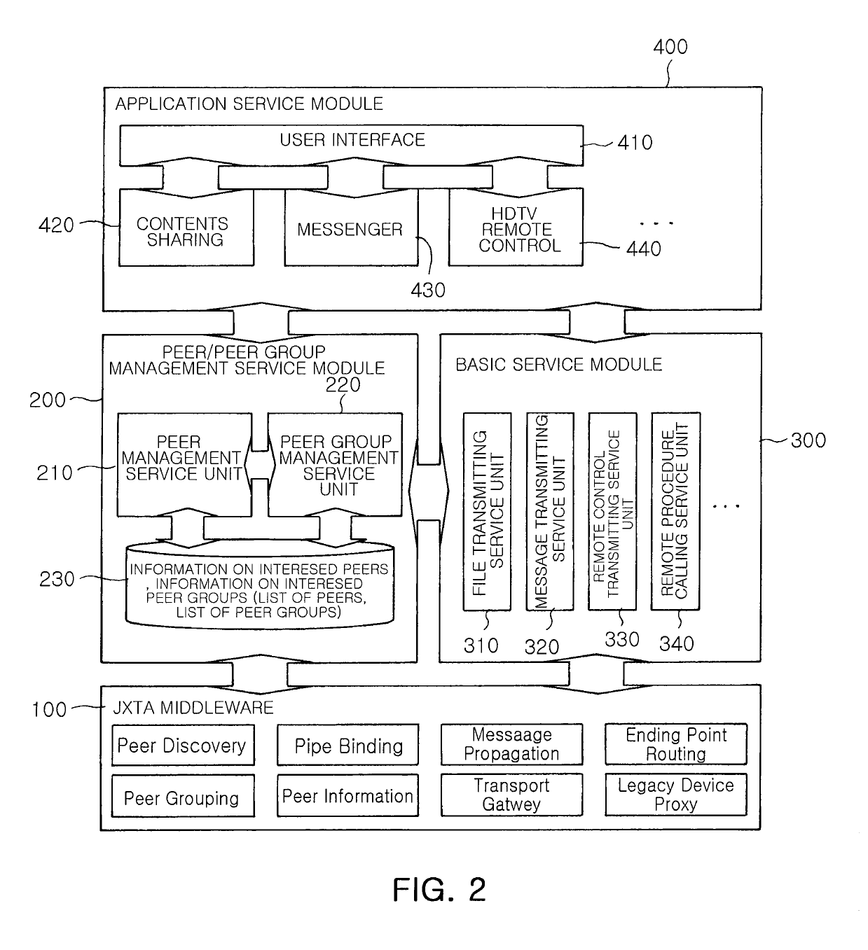

FIG. 2 is a block diagram illustrating the P2P-network-based extended home service apparatus according to the embodiment of the present invention.

Referring to FIG. 2, the P2P-network-based extended home service apparatus includes a middleware (for example, a JXTA middleware) 100, a peer/peer group management service module 200, a basic service module 300, and an application service module 400.

The JXTA middleware 100 is constructed in accordance with specifications of the JXTA protocol that is defined to provide P2P application solutions by JXTA Project Team of Sun Microsystems Inc. The JXTA is a set of protocols that are independent of languages and platforms for P2P networking. The JXTA middleware 100 includes a peer discovery protocol, a peer resolver protocol, a rendezvous protocol, a peer information protocol, a pipe binding protocol, and an end-point routing protocol. In addition, the JXTA middleware 100 may further include a peer grouping protocol, a message propagation protocol, a transport gateway protocol, and a legacy device proxy protocol. These protocols are used for P2P networking, communication between the peers located on the P2P network, generation of a peer group, and searching for a peer or a peer group.

The peer/peer group management service module 200 includes a peer management service unit 210, a peer group management service unit 220, and a storage unit 230 such as a local disk.

The peer management service unit 210 manages information of peers and has a function of communicating peers. The peer management service unit 210 stores the peers that are searched from the currently-connected P2P network in a list of peers of the storage unit 230. When a user registers a specific peer in the list of peers as an interested peer, the peer management service unit 210 stores the registered interested peer in the list of peer of the storage unit 230.

The peer group management service unit 220 stores a searched peer group in a list of peer groups of the storage unit 230. When the user registers a specific peer group as an interested peer group, the peer group management service unit 220 permanently stores the registered interested peer group in a list of peer groups of the storage unit 230. In case of a security peer group that requests for security, the peer group management service unit 220 also stores broadcasted information on peer group issued by the security peer group and a security peer group access key (password).

The basic service module 300 is constructed with libraries of basic services for generation and providing of the P2P application service. The basic service module 300 includes a file transmitting service unit 310, a message transmitting service unit 320, a remote controlling service unit 330, and a remote procedure calling service unit 340. Upper-level application service modules call functions from theses service units.

The application service module 400 includes a user interface 410 which functions as an external interface. The application service module 400 actually provides application services to users. The application service module 400 can provides a contents sharing service 420, a messenger service 430, an HDTV remote control service 440, or other various application services. These application services can be developed by using the management service modules and the basic service module provided by a service developer.

As described above, the P2P-network-based extended home service apparatus (service platform) are installed in a peer terminal so that a user can use the application service, that is, the P2P-network-based extended home service.

Now, a method in which the P2P-network-based extended home service apparatus installed in the peer terminal provides the P2P-network-based extended home service to the user will be described with reference to the accompanying drawings.

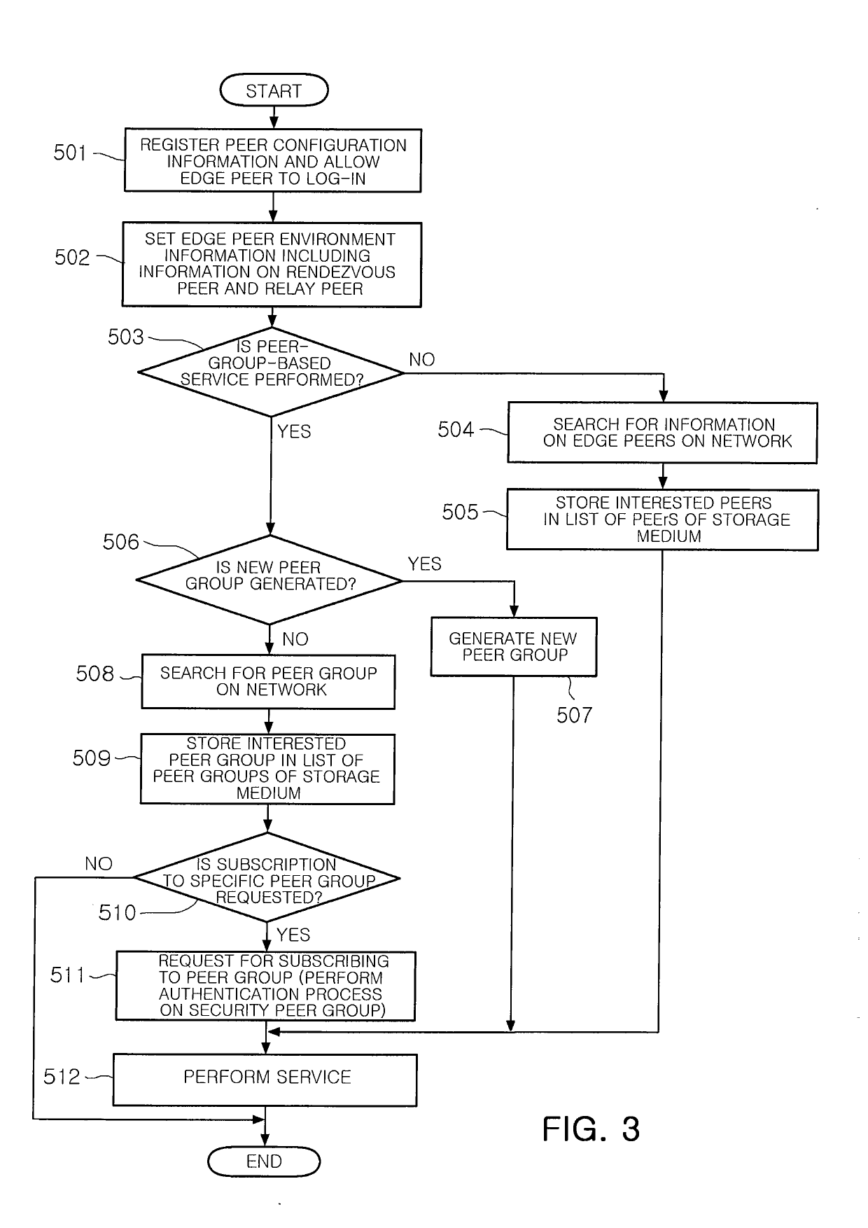

FIG. 3 is a flowchart illustrating a method in which a P2P-network-based extended home service apparatus provides an extended home service according to an embodiment of the present invention. In the following description, a terminal of one edge peer 10 among terminals of the edge peers 20, and 30 shown in FIG. 1 is exemplified. However, it should be noted that the same description is available for terminals of the other edges 20 and 30 or the rendezvous/relay peers 40.

Referring to FIG. 3, in Step 501, the extended home service apparatus performs an initialization process. Namely, the extended home service apparatus registers information used for accessing the rendezvous/relay peer 40 or other edge peers 20 and 30 and configuration information of the edge peers in advance. When a user requests for access (log-in), the extended home service apparatus verifies information input by the user to process the log-in. More specifically, when the extended home service apparatus receives a peer identifier and a password input by the user, the extended home service apparatus compares the peer identifier and the password with the previously-registered information and accepts the access request of the user. Here, the peer identifier and the password are allocated to the user by a managing peer.

After the user gains log-in to the peer terminal provided with the extended home service apparatus, in Step 502, the extended home service apparatus sets peer environment information of the extended home service apparatus by using information on the rendezvous peer and information on the relay peer and peer names stored in the extended home service apparatus. Here, the peer environment information may include peer names, network environment settings, and rendezvous/relay peer settings.

In Step 503, the extended home service apparatus determines whether or not to perform a peer-group-based service. In case of performing the peer-group-based service, the extended home service apparatus proceeds to Step 506. In case of performing a peer service not the peer-group-based service, in Step 504, the extended home service apparatus activates the peer terminal of the extended home service apparatus based on the set peer environment information and searches for other edge peer terminals that are activated on the network so as to provide the service to the user. Sine the edge peer terminals broadcasts resources thereof, the extended home service apparatus provided to the searching edge peer terminal can search for the currently-activated edge peer terminals by collecting the broadcasted information.

The extended home service apparatus registers information on the searched edge peer terminals in a list of peers and displays the list of peers on a display unit of the peer terminal of the user so that the user can check the list of peers. The user checks the list of peers and selects an interested edge peer terminal. In Step 505, the extended home service apparatus registers information on the interested edge peer terminal selected by the user in the list of peers and proceeds to Step 512 so as to perform a service associated with an arbitrary interested peer terminal among the peer terminals in the list of peers. The information on the edge peers registered in the list of edge peers is permanently stored in a storage unit. Due to the registration, when the user logs in again, the extended home service apparatus needs not to search for the information on the edge peers.

As a result of the determination in Step 503, in case of performing the peer-group-based service, in Step 506, the extended home service apparatus determines whether or not the user requests for generating a new peer group. If there is the request for generating a new peer group, in Step 507, the extended home service apparatus receives information on characteristics of the peer group from the user and generates a new peer group. After that, the extended home service apparatus proceeds to Step 512. The peer group may be generated according to preference, hobbies, or characteristics of the users. Parameters such as a name of peer group, a description of peer group, a type of peer group, and password may be used to generate the peer group. When the user requests for removing the peer group, the extended home service apparatus removes the peer group from the list of peer groups of the storage unit 230.

If there is no request for generating a new peer group, in Step 508, the extended home service apparatus searches for information on the peer groups which is broadcasted by other edge peers on the network. In Step 509, the extended home service apparatus selects interested peer groups from the list of peer groups based on the broadcasted information on the peer groups and registers the selected interested peer groups in the list of peer groups of the storage unit 230

When the user is to check the list of peer groups by using the peer terminal, the extended home service apparatus displays the list of peer groups on the display unit of the peer terminal. When the user is to subscribe as a member of a peer group among the peer groups displayed on in the list of peer groups, the user selects a specific peer group, that is, an interested peer group. In Step 510, the extended home service apparatus determines whether or not the user requests for subscribing in the specific peer group. If there is no request for subscribing, the procedure is ended.

If there is a request for subscribing, in Step 511, the extended home service apparatus performs the subscribing process by registering the information on the peer terminal of the extended home service apparatus, that is, the user information in the interested peer group selected by the user. In case of the security peer group, an authentication process is performed. According to the result of authentication, the user may be subscribed in the interested peer group. Next, the extended home service apparatus proceeds to Step 512. The authentication process may be performed by comparing the information of the user with the information on the peer group stored in the storage unit 230, that is, the broadcasted information on the peer group issued by the security peer group and a security peer group access key (password) to verify the user.

After the aforementioned processes are performed, in Step 512, the extended home service apparatus performs services such as file transmission, remote controlling, and remote procedure calling with respect to an arbitrary interested peer terminal in the list of peers or an arbitrary interested peer group in the list of peer groups. Accordingly, the user can be rapidly provided with various services that are performed by the peer terminal having the extended home service apparatus.

In the aforementioned embodiments of the present invention, an extended home service platform is implemented, so that users can be provided with various contents and services anytime, anywhere via a virtual home network. In addition, in the embodiments of the present invention, a service developer can develop services by using an application program interface (API) basically provided by a service platform without directly control of a complicated lower-level middleware, so that it is possible to greatly reduce a developing period for a new service by reusing a service after initial developing of the service. Accordingly, due to the reduction of the developing period, a user can be rapidly provided with the new service coping with a request of the user.

The methods according to the embodiments of the present invention may be implemented by a program and stored in a computer-readable recording medium such as CD-ROMs, ROMs, floppy disks, hard disks, and optical magnetic disks.

According to the present invention, a service developer can develop and modify application services by using an application program interface provided by an extended service platform without checking all the contents of a middleware of a P2P platform, so that it is possible to greatly reduce a developing time and cost. In addition, it is possible to rapidly cope with requests of a P2P service user. In addition, the P2P service user can be rapidly provided with various P2P services. In addition, the P2P service user can be provided with more reliable and safer P2P-based extended home service environments.

While the present invention has been shown and described in connection with the exemplary embodiments, it will be apparent to those skilled in the art that modifications and variations can be made without departing from the spirit and scope of the invention as defined by the appended claims.

What is claimed is:

1. An extended home service apparatus for providing an extended home service to a user in a P2P (peer-to-peer) network for connecting a plurality of peer terminals in which the extended home service apparatuses are included the peer terminals, the extended home service apparatus comprising:
a middleware which manages a protocol for communication with other peer terminals and providing the extended home service on the P2P network;
a peer/peer group management service module which manages information on the peers and information on peer groups by using the protocol managed by the middleware and communicates with other peer terminals activated on the P2P network;
a basic service module which generates and manages information on services which are to be provided to the user; and
an application service module which provides an interface to the user and the other peer terminals by using the protocol managed by the middleware, calls a service requested by the user from the basic service module, and provides the service to the user.

2. The extended home service apparatus of claim 1, wherein the peer/peer group management service module comprises:
a peer management service unit which registers peer configuration information of the P2P network, searches for other peer terminals activated on the P2P network, manages the information on the peers on the searched peer terminals, and sets peer environment information on the peer terminal of the extended home service apparatus;
a peer group management service unit which searches for a peer group generated by the other peer terminals and manages information on the searched peer group and information on a peer group generated by the extended home service apparatus; and
a storage unit which stores information on the searched peer terminals and information on the searched peer group.

3. The extended home service apparatus of claim 2, wherein the peer group management service unit performs a subscribing process for taking part in a peer group which the user selects from the interested peer groups registered in a list of peer groups.

4. The extended home service apparatus of claim 3, wherein the peer group management service unit performs an authentication process on the subscribed peer group that is a security peer group by using information on the subscribed peer group.

5. The extended home service apparatus of claim 2, wherein, when the user requests a new peer group to be removed, the peer group management service unit removes the new peer group from the interested peer groups in the list of peer groups.

6. The extended home service apparatus of claim 2, wherein the storage unit permanently stores the information on the interested peers and the information on the interested peer groups in the list of peers and the list of peer groups according to user's selection.

7. A method for providing an extended home service to a user in an extended home service apparatus provided to an arbitrary peer terminal among peer terminals in a P2P network in which a plurality of the peer terminals provided with the extended home service apparatuses are connected to each other via a virtual home network, the method comprising:
performing initialization for registering peer configuration information of the P2P network and executing a service;
setting edge peer environment information by using the registered peer configuration information when the user has access to the arbitrary peer terminal;
searching for peer terminals activated on the P2P network;
registering information on the searched interested peer terminals in a list of peer terminals; and
performing a service with a interested peer terminal which the user selects from the list of peer terminals and providing the service to the user.

8. The method of claim 7, wherein the performing of initialization for executing a service comprises:
inputting a peer identifier and a password allocated by a managing peer on the P2P network and requesting for access to the peer terminal of the extended home service apparatus;
comparing the input peer identifier and password with previously-registered information; and
accepting the requesting for access if the compared information is matched.

9. The method of claim 7, wherein the information on the searched interested peer terminal is permanently stored in the list of peer terminals of a storage unit of the extended home service apparatus.

10. A method for providing an extended home service to a user in extended home service apparatus provided to an arbitrary peer terminal among peer terminals in a P2P network in which a plurality of the peer terminals provided with the extended home service apparatuses are connected to each other via a virtual home network, the method comprising:
performing initialization for registering peer configuration information of the P2P network and executing a service;
setting edge peer environment information by using the registered peer configuration information when the user has access to the arbitrary peer terminal;
searching for peer groups generated by other peer terminals activated on the P2P network when the user requests for executing a peer-group-based service;
registering information on a peer group which the user selects from the searched interested peer groups in a list of peer groups;
performing a subscribing process for taking part in a peer group which the user selects from the interested peer groups registered in the list of peer groups; and
performing a service with the subscribed peer group and providing the service to the user.

11. The method of claim 10, further comprising performing an authentication process on the subscribed peer group that is a security peer group.

12. The method of claim 10, further comprising:
generating a new peer group for sharing contents and a service with the peer terminal of the extended home service apparatus when the user requests for executing the peer-group-based service;
storing the generated peer group in a list of peer groups of a storage unit; and
executing the service shared by the generated new peer group and providing the service to the user.

13. The method of claim 12, further comprising removing the new peer group which the user requests for removing from the list of peer groups of the storage unit.

14. The method of claim 10, wherein information on the interested peer group that user selects is permanently stored in the list of peer groups of the storage unit of the extended home service apparatus.

15. The method of claim 10, wherein the performing of initialization for executing a service comprises:
inputting a peer identifier and a password allocated by a managing peer on the P2P network and requesting for access to the peer terminal of the extended home service apparatus;
comparing the input peer identifier and password with previously-registered information; and
accepting the requesting for access if the compared information is matched.
